(19) United States
(12) Patent Application Publication
(10) Pub. No.: US 2012/0207020 A1
(43) Pub. Date: Aug. 16, 2012

(54) Load-Balancing Structure for Packet Switches with Minimum Buffers Complexity and its Building Method

(76) Inventors: Hui Li, Guangdong (CN); Shuoyan Li, Guangdong (CN); Liangmin Lin, Guangdong (CN); Ruiyuan Li, Guangdong (CN); Huiyao An, Guangdong (CN); Feng Li, Guangdong (CN); Qinshu Chen, Guangdong (CN); Minglong Zhang, Guangdong (CN); Xi Chen, Guangdong (CN)

(21) Appl. No.: 12/995,702

(22) PCT Filed: Oct. 31, 2009
(86) PCT No.: PCT/CN09/74737

§ 371 Date: Dec. 2, 2010

(51) Int. Cl. H04L 12/26

(52) U.S. Cl. 370/235

(57) ABSTRACT

This invention provides a structure of load-balancing packet switches with minimum buffers complexity and its concomitant methodology. It abandons the VOQ between the first stage and the second stage fabrics, which has no problems of queue delay and packets out-of-sequence. Therefore, this invention solves the packets out-of-sequence problem in load-balancing Birkhoff-von Neumann switching structure and improves the end-to-end throughput. Moreover, it greatly reduces the buffer complexity to O(N).

### TECHNICAL FIELD OF THE INVENTION

This invention relates to communication and, more particularly, to a structure of load-balancing packet switches with minimum buffers complexity and its concomitant methodology.

### BACKGROUND OF THE INVENTION

The so-called switching structure, in the application of telecommunications, is a kind of network equipment which achieves routing for data units and forwards them to the next hop node.

As internal capacity in switching structure is limited, some ports or internal lines become saturation while others are still in idle state when traffic arriving switching structure is unbalanced. In order to avoid unbalanced traffic, load-balancing switching structure is used to solve this problem. The structure makes traffic uniformly distributed inside of it, that is, the utilization of all ports and internal lines are identical. Such switching structure can improve throughput to the maximum extent and decrease the internal blocking.

The structure of load-balancing Birkhoff-von Neumann (LB-BvN) switches can solve the problem of internal blocking.

As shown in FIG. 1, the LB-BvN switch consists of two crossbar switch stages and one set of virtual output queue (VOQ) between these stages. The first stage performs load balancing and the second stage performs switching. This switch structure does not need any schedulers since the connection patterns of the two switch stages are deterministic and are repeated periodically. The connection patterns should be selected so that in every consecutive N timeslots, each input should connect to each output exactly once with a duration of one time slot. It is clear that said load-balancing switching structure can solve the problem of data blocking.

However, traffic is different and unbalance for each input port, the number of packets belongs to different flows is variable, so the size of mid-stage VOQ is also different. As queues are served uniformly independent of their sizes, this LB-BvN structure brings about problems such as queuing delay and packets out-of-sequence. Packets out-of-sequence makes TCP (Transmission Control Protocol) trigger fast recovery, and reduces its sliding window by half, thus the end-to-end throughput of this connection is reduced by half. Moreover, because of adopting VOQ, the complexity of packet buffers is at least O(N²). As the switching scale increases, the hardware implementation and cost become unrealistic. Hence, these properties make it unsuitable for very large scale switching structures.

### SUMMARY OF THE INVENTION

The present invention provides a structure of load-balancing packet switches and its concomitant methodology which solves the problem of packets out-of-sequence to improve end-to-end throughput and to greatly reduce the complexity of buffers.

The invention provides a method for constructing a load-balancing packet switching structure with minimum buffer complexity. It comprises:

S1: Dividing the structure which is based on self-routing concentrators into a two-stage switching fabric. The first stage accomplishes the function of load balancing and the second stage self-routes and forwards the incoming data.

S2: Appending a packet aggregated splitter (PAS) and an Input aggregating ring queue (IARQ) at each of the input group port of the first stage fabric and configuring a cell assembly sender (CAS) and an output assembly ring queue (OARQ) behind each output group port of the second stage fabric which are used to reordering the data blocks according to their input group self-routing address.

S3: When the packets arrive, they will be buffered orderly in IARQ and then are split into cells with equivalent length by PAS, and M cell slices again with equivalent length in order to implement load balancing. After labeled by self-routing tags, these cells are sent to middle stage through the first stage fabric by M parallel paths and all of them destined to the same output group (OG) are transmitted and put into corresponding FIFOs and then they are sent to the second stage fabric before finally assembled at each output according to self-routing tags.

The present invention adopts further technical solutions as below: the output of first stage fabric is connected to the input of the second stage fabric by a set of middle line groups, and a set of FIFO queues is also configured.

The present invention adopts further technical solutions as below: the load-balancing structure is based on self-routing concentrators and adopts a distributed self-routing scheme.

The present invention adopts further technical solutions as below: the first stage fabric is responsible for uniformly distributing the incoming traffic to the input ports of the second stage fabric.

The present invention adopts further technical solutions as below: the second stage fabric forwards the data to their final destinations in a self-routing scheme by the self-routing tags at the head of each data slice.

The present invention adopts further technical solutions as below: it provides a structure of load-balancing packet switches with minimum buffers complexity wherein the structure includes the self-routing concentrators based first stage fabric which accomplishes the function of load balancing and the second stage which just self-routes and forwards the incoming data. A packet aggregated splitter (PAS) and an input aggregating ring queue (IARQ) are appended at each of the input group port of the first stage fabric, and a cell assembly sender (CAS) and an output assembly ring queue (OARQ) are configured behind each output group port of the second stage fabric which are used to reordering the data blocks according to their input group self-routing address. A set of FIFO queues is set between two stages fabric. The IARQ is used to store the cell slices destined to the same OG, the FIFO queues are used to buffer data destined to store the cell slices destined to the same output group, and the OARQ is used to assemble the slices belong to the same input group (IG) according to self-routing tags.

The present invention adopts further technical solutions as below: the output of first stage fabric is connected to the input of the second stage fabric by a set of middle line groups.

The present invention adopts further technical solutions as below: the load-balancing structure is based on self-routing concentrators and adopts a distributed self-routing scheme.

The present invention adopts further technical solutions as below: the first stage fabric is responsible for uniformly distributing the incoming traffic to the input ports of the second stage fabric.

The present invention adopts further technical solutions as below: the second stage fabric forwards the reassembled data coming from the first stage fabric to their final destinations in a self-routing scheme by the self-routing tags at the head of each data slice.

Comparing this structure with the LB-BvN, it is clear that this invention of load-balancing packet switches with minimum buffers complexity and its concomitant methodology abandons the VOQ between the first stage and the second stage fabrics, which has no problems of queuing delay and packets out-of-sequence. Therefore, this invention solves the problem of packets out-of-sequence in load-balancing Birkhoff-von Neumann switching structure and improves the end-to-end throughput. Moreover, it greatly reduces the buffer complexity to O(N).

### BRIEF DESCRIPTION OF THE DRAWINGS

FIG. 1 illustrates the schematic of conventional load-balancing Birkhoff-von Neumann switching structure;

FIG. 2a illustrates the schematic of this invention's concomitant methodology of load-balancing packet switches with minimum buffers complexity;

FIG. 2b is a specific diagram of the multi-path self-routing switching structure with parameters N=128, G=8, M=16 of FIG. 2a;

FIG. 3 illustrates a schematic of the minimum buffers complexity load-balancing packet switching structure model of this invention;

FIG. 4 illustrates a schematic of the PAS, IARQ and corresponding buffer method in the minimum buffers complexity load-balancing packet switching structure model of this invention;

FIG. 5 illustrates a schematic of the middle stage FIFO queues and corresponding buffer method in the minimum buffers complexity load-balancing packet switching structure model of this invention;

FIG. 6 illustrates a schematic of the CAS and OARQ and corresponding buffer method in the minimum buffers complexity load-balancing packet switching structure model of this invention;

FIG. 7 illustrates a schematic of the aggregated flow splitting method;

FIG. 8a illustrates a schematic of the cell data format in the minimum buffers complexity load-balancing packet switching structure model of this invention; and

FIG. 8b illustrates a schematic of the cell slice data format in the minimum buffers complexity load-balancing packet switching structure model of this invention.

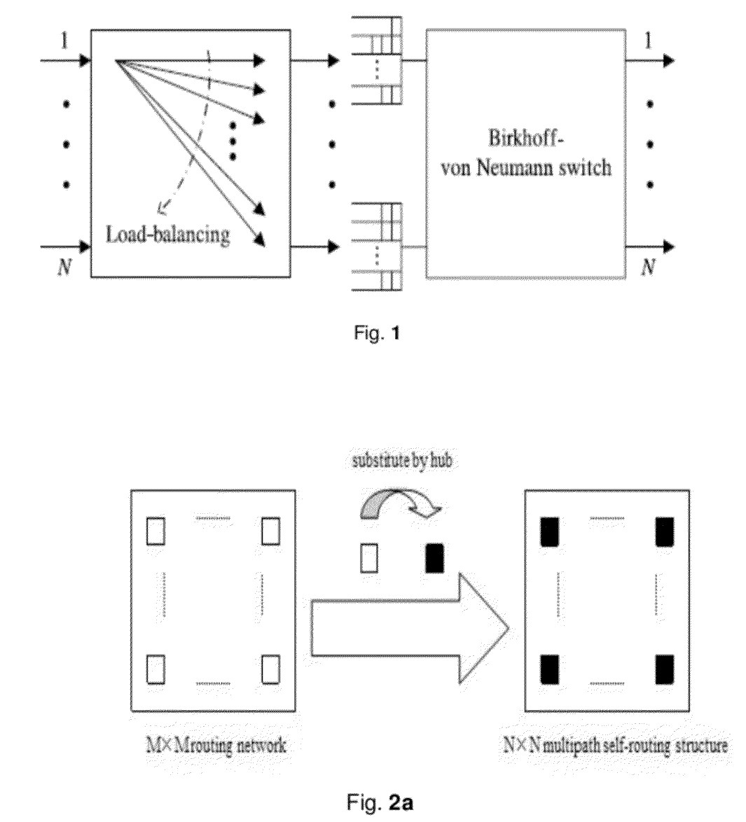

### DETAILED DESCRIPTION OF THE INVENTION

Below is a detailed description of the invention through a better implementation way, and it is not used to restrict the invention. For any revise, identical substitute by any general technical personnel in this field should be protected.

The invention which is based on self-routing concentrators provides a packet switching structure, and the structure which mainly uses concentrators and line group technology can be constructed based on the routable multi-stage interconnect network (MIN).

The invention provides a method for constructing a load-balancing packet switching structure with minimum buffer complexity. The method comprises: S1: Dividing the structure which is based on self-routing concentrators into a two-stage switching fabric. The first stage accomplishes the function of load balancing and the second stage self-routes and forwards the incoming data. S2: Appending a packet aggregated splitter (PAS) and an Input aggregating ring queue (IARQ) at each of the input group port of the first stage fabric and configuring a cell assembly sender (CAS) and an output assembly ring queue (OARQ) behind each output group port of the second stage fabric which are used to reordering the data blocks according to their input group self-routing address. S3: When the packets arrive, they will be buffered orderly in IARQ and then are split into cells with equivalent length by PAS, and M cell slices again with equivalent length in order to implement load balancing. After labeled by self-routing tags, these cells are sent to middle stage through the first stage fabric by M parallel paths and all of them destined to the same output group (OG) are transmitted and put into corresponding FIFOs and then they are sent to the second stage fabric before finally assembled at each output according to self-routing tags.

The present invention provides a structure of load-balancing packet switches with minimum buffer complexity wherein the structure includes the self-routing concentrators based first stage fabric which accomplishes the function of load balancing and the second stage which just self-routes and forwards the incoming data. A packet aggregated splitter (PAS) and an input aggregating ring queue (IARQ) are appended at each of the input group port of the first stage fabric, and a cell assembly sender (CAS) and an output assembly ring queue (OARQ) are configured behind each output group port of the second stage fabric which are used to reordering the data blocks according to their input group self-routing address. A set of FIFO queues is set between two stages fabric. The IARQ is used to store the cell slices destined to the same OG, the FIFO queues are used to buffer data destined to the same output group, and the OARQ is used to assemble the slices belong to the same input group (IG) according to self-routing tags.

The first stage fabric is connected to the second stage fabric by a set of middle line groups, and a set of FIFO queues. The load-balancing structure is based on self-routing concentrators and adopts a distributed self-routing scheme. The first stage fabric is responsible for uniformly distributing the incoming traffic to the input ports of the second stage fabric. The second stage fabric just forwards the data to their final destinations in a self-routing scheme by the self-routing tag at the head of each data slice.

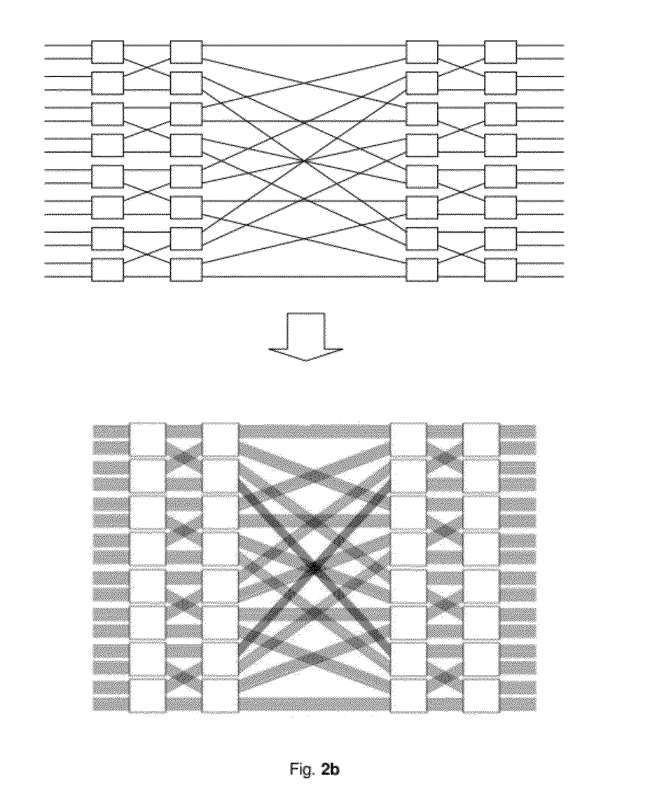

As illustrated in FIG. 2a, before constructing the self-routing concentrators based packet switching structure by an M×M routable multi-stage interconnection network, usually, let N=2ⁿ, N=M×G, M=2^{m}, G=2^{g}. First, construct an M×M routable network (the Divide-and-conquer networks are often chosen for their modularity, scalability and optimal layout complexity). Then, substitute each 2×2 routing cell with a 2G-to-G self-routing group concentrator. Finally, substitute each line with G parallel lines. An N×N network with M output (input) groups and each group with G output (input) ports is built up. A 2G-to-G concentrator has two input and output groups, and the output group having smaller address is called 0-output group while the larger one is called 1-outptut group. For the same reason, two input groups are called 0-input group and 1-input group. For each signal, it is not differentiate to distinguish the output ports of the same group, as they are equivalent.

As illustrated in FIG. 2b, line groups and 16-to-8 concentrators can be used in 16×16 network showed in FIG. 2a to obtain a 128×128 network with G=8.

Logically, a 2G-to-G concentrator is equal to 2x2 basic routing cell, as the address of its G ports in each input (output) group is identical. A 2G-to-G concentrator is a 2G×2G sorting switching module which can separate the larger/smaller G signals and transmit them to the corresponding output ports.

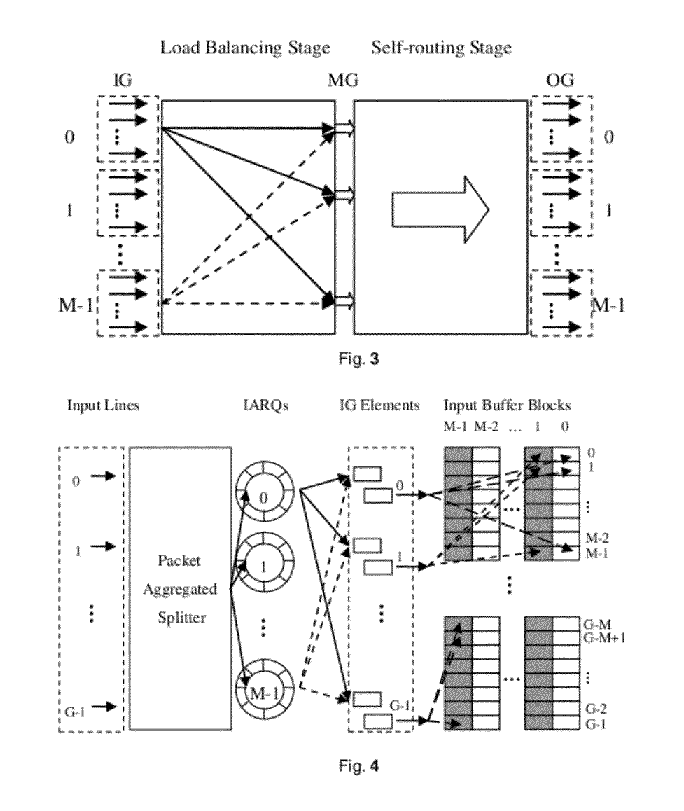

As illustrated in FIG. 3, two multi-path self-routing switching fabrics are concatenated to compose the main body, and the whole inventing minimum buffers complexity load-balancing packet switching structure is composed by appended a PAS (packet aggregated splitter) and a IARQ (input aggregating ring queue) ahead of the first stage fabric and configured CAS (cell assembly sender) and OARQ (output assembly ring queue) behind the second stage fabric. In order to adjust the sequence of cell slices, FIFO queues are adopted in the middle stage, so as to construct the structure of load-balancing packet switches with minimum buffers complexity.

Actually, the first stage fabric serves as a load-balancer, which is responsible for uniformly distributing the incoming traffic to the input orts of the second stage fabric. Consequently, the second stage fabric just forwards the data to their final destinations in a self-routing scheme by the self-routing tag at the head of each data slice. Every G inputs (outputs) are bundled into an input (output) group, thus M groups are formed on the input (output) side (N=M×G). To ease presentation, let IGᵢ (OGᵢ) denotes a specific input (output) group, and MGᵢ represents a line group between the two stages (i,j=0 to M−1).

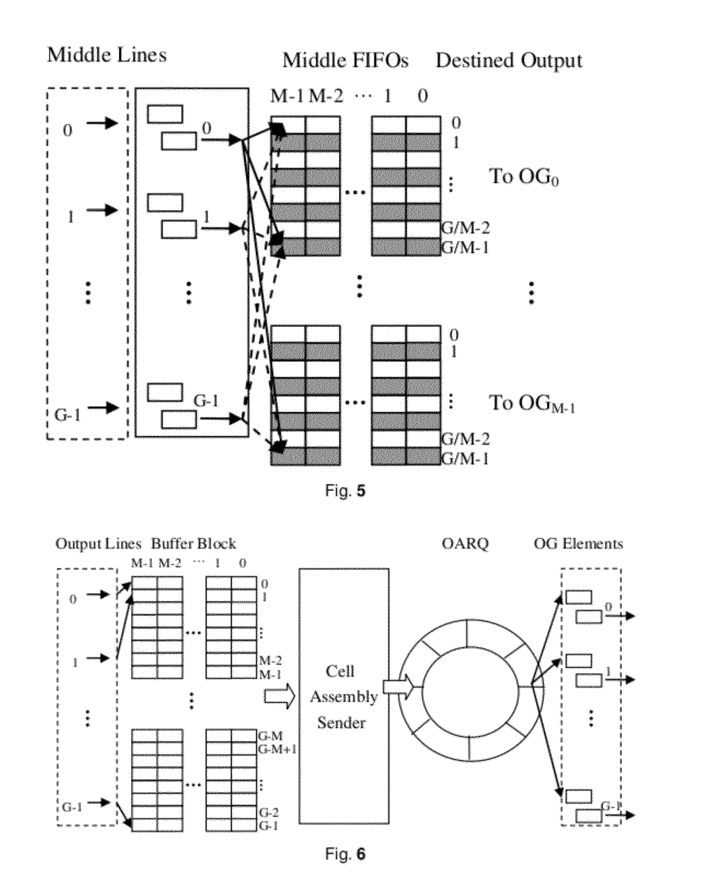

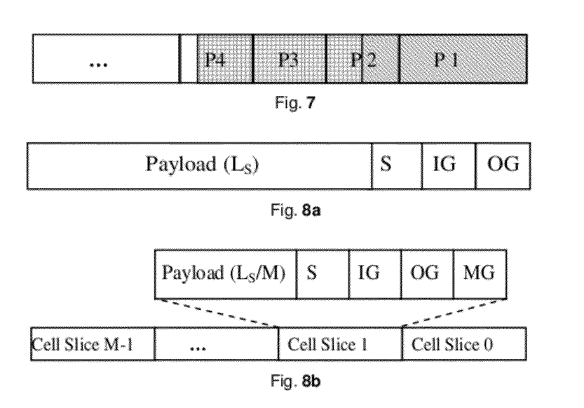

Generally, for our proposed scheme, the processing of arriving packets in each time slot is composed by several sequential phases, which should be executed in pipeline for keeping the transferring as fast as possible:
1) Arrival phase: New packets arrive at the IGᵢ (i=0, 1, . . . , M−1) during this phase.
2) Aggregated split phase: PASs at each IGᵢ, check the arriving packets to figure out their OGs, put the packets into the corresponding IARQ based on AF (IGᵢ, OGⱼ). After splitting the aggregated flows by Lₛ, cells are put into IG Elements in round-robin manner as shown in FIG. 7. Then PASs cut the cells, and store the cell slices into input buffer blocks parallel as shown in FIG. 4. The functions of each PAS algorithm are as follow: the split sequence label algorithm (Algorithm 1) will figure out the sequence number S (which is used for reassembling packets at the output); for load balancing purpose, the cell cutting algorithm (Algorithm 2) will generate the MG (middle group) port number, which is used as the self-routing tag for the data go through first stage fabric. When the cells are put into IARQ, sequence number S and IG (OG) tags will be added. And MG tags will be added at the moment cell slices are stored into input buffer blocks. The data format is shown in FIG. 8a and FIG. 8b.
3) Balancing phase: According to MG, cell slices are self-routed through the first stage and reach their corresponding middle group.
4) Slices assembling phase: In this phase, all the cell slices destined to the same OG are transmitted and put into G/M corresponding FIFOs, as FIG. 5 shows.
5) Switching phase: According to OGj, cell slices are self-routed through the second stage and reach the destined output group.
6) Reassembly phase: Based on IGᵢ and S, the queue storing algorithm (Algorithm 3) stores the cells into the corresponding position of OARQ at each output group. Then, CAS moves integral packets into corresponding OG Elements in round-robin manner for waiting to be transmitted at next time slot, as FIG. 6 shows.
7) Departure phase: Packets depart from OGⱼ (j=0, 1, . . . , M−1) in this phase.

Here is a detailed description of the function of PAS, CAS, IARQ, middle stage FIFO queues, OARQ, implementation of buffers and algorithms.

Packet aggregated splitter: assume that, G packets enter switching fabric form IGᵢ at some timeslot, and aⱼ of them destine to OGⱼ (j=1, 2, . . . , M). PAS will store the aⱼ packets destine to OGⱼ into the corresponding IARQ. Then according to Algorithm 1, PAS splits the data in IARQ with fixed length L_{S} (see FIG. 7), and figures out tag S of packets. After adding S, IGⱼ and OGⱼ, the cell will be moved to the corresponding IG Element in round-robin manner. And then, executes Algorithm 2.

Cell assembly sender: assume that, G packets from OGⱼ enter CAS. Firstly, CAS counts the number of cell slices from each IGᵢ; then according to Algorithm 3, stores the data of the same AF into the OARQ, finally discards all tags, and put the integral packets into corresponding OG Elements for departure, as showed in FIG. 6.

FIFO queue: as FIG. 5 shows, cell slices destined to the same OG are stored in one FIFO queue in the middle stage to make sure that less than G/M slices are transmitted parallel to any OG of the second stage by each middle stage group in every slice time. Thus, it can make sure that there is no blocking in the second stage fabric.

Algorithm 1: This algorithm computes sequence number of the cell split from AF which is used in reassembling at output. In initialization, S=0. Every time data of L_{S} length split from AF, add S, OGⱼ and IGᵢ in front of the data, as FIG. 8a shows. And then adjusts S=(S+1) mod 2G, that is, S is a number with (g+1) bits (as in reassembly phase, the size of OARQ is 2GL_{S}, G=2^{g}).

Algorithm 2: This algorithm figures out the MG of cell slices, to implement load balancing. Along with the cell being split into M cell slices, each one of them will be labeled by 0, 1, . . . , (M−1) in sequence as the MG tag. And then, all cell slices belonged to the same cell will be stored into M small buffer blocks parallel as shown in FIG. 4 with the same filling pattern.

Algorithm 3: This algorithm is used to reassembling the packets that arrive at outputs with each AF (IGᵢ, OGⱼ), by different aggregated flows. Assume that, at time slot t, the number of cell slices from output group OGⱼ is G×M, and of which cell slices from each input group IGᵢ is aᵢ (cell slices denoted by IGᵢ (S, MG), where S and MG are their corresponding tags). AF flows are indexed by IGᵢ, and at clockwise of AF (IG₀), AF (IG₁), . . . , AF (IG_{M-1}), reserve the OARQ memory with the size of (aᵢ×Lₛ)/M for each AF (IGᵢ) respectively. For some IGᵢ, if the first arriving cell is IGᵢ (S, MG), just put it at the (S−Sₘᵢₙ+MG)ₜₕ position of the whole allocated buffer whose unit size of memory is L_{S}/M; then other cell slices of the same AF flow arriving latter will be stored in sequence, and this is helpful to check the integrality of packet. If the packet is integral, it will be put into corresponding OG Element in round-robin manner for delivering at next time slot. Otherwise, the data will be thrown away.

IARQ which is appended ahead of the load-balancing switching fabric segments and packages each packet leaving for the same output ports. Data slices are re-sequenced in OARQ behind the output group port. As the number of fabric output group ports is M, packets should be evenly cut into M data slices. However, the size of a 2G-to-G self-routing concentrator group is G, so the relationship between M and G will influence the method of packaging and delivering.

Three methods of packaging and delivering corresponding to three kinds of relationship are given below.

1) M=G: this is the simplest case. Two input groups connect to a 2G-to-G self-routing concentrator whose scale is 2G×2G. A data block in any IARQ is cut into M data slices during aggregated split phase, so there are M data slices in each input port of each 2G-to-G self-routing concentrator. For M=G, M data slices in any IARQ can be transmitted to input ports in one timeslot. There are no buffers in fabric, and there is no need to execute data slices reassembling in middle stage FIFO queues, hence, the transmission delay of M data slices are identical, that is, they arrive at OARQ behind the output ports in the same timeslot. After recombined into original data blocks, they are transmitted to line cards on output ports. Then, all cell data can enter switching fabric in one cell data time.

2) M<G: M=2^{m}, G=2^{g}, so G is 2^{x} times as large as M (x is a positive integer). As IARQ cell data blocks are cut into M data slices, that is, there are at most G×M slices for each input group port of every self-routing concentrator. Slices belong to the same cell enter switching fabric parallelly through M input paths, and cell slices destined to the same OG are stored in one FIFO queue at the middle stage to make sure that less than G/M slices are transmitted parallel to any OG of the second stage from each middle stage group in every slice time. Thus, it can make sure that there is no blocking in the second stage fabric. Hence, all cell data can enter switching fabric in one cell data time.

3) M>G: M=2^{m}, G=2^{g}, so M is 2^{x} times as large as G (x is a positive integer). As IARQ cell data blocks are cut into M data slices, so there are at most G×M slices for one input port group of every self-routing concentrator. Because M>G, it is impossible to send slices belong to the same cell to the switching fabric simultaneously. To solve this problem, M data slices are divided into 2^{x} parts and every part has G data slices. Meanwhile, in order to avoid internal blocking in load-balancing fabric, G slices belong to a same packet are sent to the switching fabric, and all the G cells from different input port are scheduled by round-robin manner. Because M>G, there is no need to execute data slices reassembling in middle stage FIFO queues. Thus, after a round-robin, all cell data can also enter switching fabric in one cell data time.

Since the packet switching structure based on self-routing concentrators can be constructed recursively, its scale is unlimited. Meanwhile, the property of its distributed and self-routing mechanism provides the possibility to achieve a large-scale on technology.

The structure, which is based on self-routing concentrators, is divided into a first stage and a second stage fabric. A PAS and an IARQ are appended to each input group port of the first stage fabric, and a CAS and an OARQ are configured behind each output group port of the second stage fabric. When the packets arrive, they are buffered orderly in IARQ, then are split into cells with equivalent length by PAS and M cell slices again with equivalent length in order to implement load balancing; after labeled by self-routing tags, cell slices are sent to middle stage through the first stage fabric by M parallel paths and all of them destined to the same output group (OG) are transmitted and put into corresponding FIFOs and then are sent to the second stage fabric before finally assembled at outputs according to self-routing tags. This invention of load-balancing packet switches with minimum buffers complexity and its concomitant methodology abandons the VOQ between the first stage and the second stage fabrics, which has no problems of queue delay and packets out-of-sequence. Therefore, this invention solves the packets out-of-sequence problem in load-balancing Birkhoff-von Neumann switching structure and improves the end-to-end throughput. Moreover, it greatly reduces the buffer complexity to O(N).

This invention provides a load-balancing structure for packet switches with minimum buffers complexity and its concomitant methodology which is based on self-routing concentrators, is divided into a first stage and a second stage fabric. A PAS and an IARQ are appended to each input group port of the first stage fabric, and a CAS and an OARQ are configured behind each output group port of the second stage fabric. When the packets arrive, they are buffered orderly in IARQ, then are split into cells with equivalent length by PAS and M cell slices again with equivalent length in order to implement load balancing; after labeled by self-routing tags, cell slices are sent to middle stage through the first stage fabric by M parallel paths and all of them destined to the same output group (OG) are transmitted and put into corresponding FIFOs and then are sent to the second stage fabric before finally assembled at outputs according to self-routing tags. This invention of load-balancing packet switches with minimum buffers complexity and its concomitant methodology abandons the VOQ between the first stage and the second stage fabrics, which has no problems of queue delay and packets out-of-sequence. Therefore, this invention solves the packets out-of-sequence problem in load-balancing Birkhoff-von Neumann switching structure and improves the end-to-end throughput. Moreover, it greatly reduces the buffer complexity to O(N).

What is claimed is:

1. A method for constructing a load-balancing packet switching structure with minimum buffer complexity, comprising:
dividing the structure which is based on self-routing concentrators into a two-stage switching fabric, the first stage accomplishes the function of load balancing and the second stage self-routes and forwards the incoming data;
appending a packet aggregated splitter (PAS) and an Input aggregating ring queue (IARQ) at each of the input group port of the first stage fabric, and configuring a cell assembly sender (CAS) and an output assembly ring queue (OARQ) behind each output group port of the second stage fabric which are used to reordering the data blocks according to their input group self-routing address;
when the packets arrive, they will be buffered orderly in IARQ and then are split into cells with equivalent length by PAS, and M cell slices again with equivalent length in order to implement load balancing; after labeled by self-routing tags, these cells are sent to middle stage through the first stage fabric by M parallel paths and all of them destined to the same output group (OG) are transmitted and put into corresponding FIFOs and then they are sent to the second stage fabric before finally assembled at each output according to self-routing tags.

2. The method of claim 1, wherein the output of first stage fabric is connected to second stage fabric by a set of middle line groups, and a set of FIFO queues is also configured.

3. The method of claim 1 or claim 2, wherein the load-balancing packet switching structure adopt a distributed self-routing scheme.

4. The method of claim 1, wherein the first stage fabric is responsible for uniformly distributing the incoming traffic to the input ports of the second stage fabric.

5. The method of claim 1, wherein the second stage fabric forwards the data to their final destinations in a self-routing scheme by the self-routing tags at the head of each data slice.

6. A minimum buffer complexity load-balancing packet switching structure, wherein the structure includes the self-routing concentrators based first stage fabric which accomplishes the function of load balancing and the second stage which self-routes and forwards the incoming data; a packet aggregated splitter (PAS) and an input aggregating ring queue (IARQ) are appended at each of the input group port of the first stage fabric, while a cell assembly sender (CAS) and a output assembly ring queue (OARQ) are configured behind each output group port of the second stage fabric which are used to reordering the data blocks according to their input group self-routing address; a set of FIFO queues is adopted between two stages fabric, said IARQ is used to store the cell slices destined to the same OG, and the OARQ is used to assemble the slices belong to the same input group (IG) according to self-routing tags.

7. The minimum buffer complexity load-balancing packet switching structure of claim 6, wherein the output of first stage fabric is connected to the input of the second stage fabric by a set of middle line groups.

8. The minimum buffer complexity load-balancing packet switching structure of claim 6, wherein the load-balancing structure is based on self-routing concentrators and adopted a distributed self-routing scheme.

9. The minimum buffer complexity load-balancing packet switching structure of claim 6, wherein the first stage fabric is responsible for uniformly distributing the incoming traffic to the input ports of the second stage fabric.

10. The minimum buffer complexity load-balancing packet switching structure of claim 6, wherein the second stage fabric forwards the reassembled data coming from the first stage fabric to their final destinations in a self-routing scheme by the self-routing tags.
